(19) United States
(12) Patent Application Publication
(10) Pub. No.: US 2016/0297986 A1
(43) Pub. Date: Oct. 13, 2016

(54) THREE DIMENSIONAL BLOCK-COPOLYMER FILMS FORMED BY ELECTROHYDRODYNAMIC JET PRINTING AND SELF-ASSEMBLY

(71) Applicants: Mustafa Serdar ONSES, Konya (TR); John A. ORGERS, Champaign, IL (US); Placid FERREIRA, Champaign, IL (US); Andrew ALLEYNE, Urbana, IL (US); Paul Franklin NEALEY, Chicago, IL (US); THE UNIVERSITY OF CHICAGO, CHICAGO, IL (US); THE BOARD OF TRUSTEES OF THE UNIVERSITY OF ILLNOIS, Urbana, IL (US)

(72) Inventors: Mustafa Serdar Onses, Meram/Konya (TR); John A. Rogers, Champaign, IL (US); Placid Ferreira, Champaign, IL (US); Andrew Alleyne, Urbana, IL (US); Paul Franklin Nealey, Chicago, IL (US)

(21) Appl. No.: 15/043,048

(22) PCT Filed: Aug. 14, 2014
(86) PCT No.: PCT/US14/51120

§ 371 Date: Feb. 12, 2016

Related U.S. Application Data
(60) Provisional application No. 61/865,919, filed on Aug. 14, 2013.

(51) Int. Cl. C09D 153/00; B41J 2/06

(52) U.S. Cl. CPC C09D 153/00; B41J 2/06

(57) ABSTRACT

Provided are methods of patterning block copolymer (BCP) films with independent control of the size, periodicity and morphology of the resulting nanoscale domains. Also disclosed are BCP patterns having discrete areas of different self-assembled BCP thin films on a surface, the BCP thin films differing in one or more of molecular weight (MW), composition, morphology, and feature size. In some implementations, multiple BCPs with different MWs can be printed onto a single substrate, thereby providing access to patterns with diverse geometries and feature sizes. The printing approaches can be applied to various BCP chemistries, morphologies and directed self-assembly (DSA) strategies. Also provided are methods of forming BCP thin films on patterns of polymer brushes formed by electrohydrodynamic printing. The methods involve direct, high resolution electrohydrodynamic delivery of random copolymer brushes as surface wetting layers to control the geometries of nanoscale domains in spin-cast and printed BCPs.

### CROSS-REFERENCE TO RELATED APPLICATION

This application claims the benefit of priority to Provisional Application No. 61/865,919, titled “HIERARCHICAL PATTERNS OF THREE DIMENSIONAL BLOCK-COPOLYMER FILMS FORMED BY ELECTROHYDRODYNAMIC JET PRINTING AND SELF-ASSEMBLY,” filed Aug. 14, 2013, all of which is incorporated herein by this reference for all purposes.

### BACKGROUND

Self-assembly in block-copolymers (BCPs) has great promise for use in nanolithography and assembly of nanomaterials, with demonstrated capabilities in fabrication of nanoscale devices. When confined in thin films, phase-separated BCPs can serve as resist layers with feature sizes and densities that are difficult or impossible to achieve with conventional optical lithography systems. In a scheme known as BCP lithography, a spin-cast film of BCP self-assembles into nanoscale structures. Selective etching removes one of the blocks, such that the remaining block can act as a conventional resist for patterning an underlying substrate by liftoff or etching. Three main challenges prevent generalized application of standard BCP lithographic methods that use spin-cast films. First, self-assembly yields randomly oriented nanoscale domains with poor long-range order. Second, spin-casting produces uniform films, without control over the location, size or geometry of the patterned areas. Third, the composition and molecular weight (MW) of the BCP fix the size, periodicity and morphology of the nanoscale domains across the film.

### SUMMARY

One aspect of the subject matter disclosed herein may be implemented in a composition including a substrate; self-assembled domains of a first block copolymer (BCP) on a first region of the substrate; and self-assembled domains of a second BCP on a second region of the substrate, where the first and second BCPs differ in one or more of composition, molecular weight, and morphology. According to various implementations, the substrate may be unpatterned or chemically or topographically patterned. Also, according to various implementations, the substrate may be neutral or preferential with respect to the blocks of the first and second BCPs. In some implementations, the self-assembled domains are oriented perpendicularly to the substrate. In some implementations, the self-assembled domains of the first and second BCPs may differ in length scale by a factor of 1.2, 1.5, 2, 5, 10, 100 or more.

Another aspect of the subject matter disclosed herein may be implemented in a composition including a substrate and a thin film including self-assembled domains of a mixture of two or more block copolymers (BCPs) on the substrate, wherein one or more of the periodicity and morphology of the self-assembled domains vary continuously across the substrate. The thin film may form a discrete region overlying the substrate. According to various implementations, the substrate may be unpatterned or chemically or topographically patterned. Also, according to various implementations, the substrate may be neutral or preferential with respect to the blocks of the BCPs. In some implementations, the self-assembled domains are oriented perpendicularly to the substrate.

Another aspect of the subject matter disclosed herein may be implemented in a method including providing a substrate; electrohydrodynamically printing an ink including a first block copolymer (BCP) on the substrate; and inducing self-assembly of the first BCP to form a thin film of nanoscale domains of the BCP. The method may further include electrohydrodynamically printing an ink including a second block copolymer (BCP), wherein the first and second BCPs have different molecular weights, compositions or morphologies. The second BCP can be printed adjacent to or over the first BCP. According to various implementations, the substrate can be chemically or topographically patterned such that substrate pattern directs the self-assembly of the first BCP, and if present, the second BCP. In some implementations, providing the substrate includes electrohydrodynamically printing an ink including a random copolymer brush on the substrate.

Another aspect of the subject matter disclosed herein may be implemented in a method including providing a substrate; electrohydrodynamically printing an ink including random copolymer brushes on the substrate and grafting the random copolymer brushes to the substrate; depositing a first block copolymer (BCP) on the random copolymer brushes; and inducing self-assembly of the first BCP to form a thin film including nanoscale domains of the BCP oriented perpendicularly to the substrate. In some implementations, providing the substrate includes providing a chemically or topographically patterned substrate. In some implementations, a substrate may be chemically patterned at a first length scale. The methods may involve electrohydrodynamically printing the ink including random copolymer at a second length scale, wherein the second length scale is greater than the first length scale. The second length scale may spatially define one component of the thin film.

These and other aspects are described below with reference to the drawings.

### BRIEF DESCRIPTION OF THE DRAWINGS

FIG. 1a shows a schematic example of forming block copolymers (BCPs) having different molecular weights (MWs) in discrete areas on a substrate, followed by self-assembly of the BCPs.

FIG. 1b shows scanning electron microscope (SEM) images of multiple BCP inks assembled into a complex layout.

FIG. 1c shows SEM images of isolated dots and lines of BCP films in sub-500 nm dimensions.

FIG. 1d shows an SEM image of self-assembled nanoscale structures with two different morphologies (lamellae forming 37-37 K at 150; cylinder forming 46-21 K, at 152) printed as lines.

FIG. 2a shows a schematic illustration of a concentric spiral pattern of alternating lines of two different BCPs

FIG. 2b shows an atomic force microscopy (AFM) image of a printed spiral pattern with line widths and spacings of 800 nm and 1 μm.

FIG. 2c shows a high-magnification SEM image of a representative region of the spiral pattern in FIG. 2b, showing self-assembled nanoscale structures with different periodicities.

FIG. 2d shows a high-magnification AFM image of the region in FIG. 2c.

FIG. 3a is an example of a calibration curve showing thickness of printed films as a function of number of printed lines per micrometer for various printing speeds.

FIG. 3b shows the periodicity of BCP domains as a function of thickness fraction of 37-37 K PS-b-PMMA in a binary mixture with 25-26 K PS-b-PMMA.

FIG. 4a-4d show cross-sectional height profiles of examples of 20 μm wide square films with varying thicknesses printed using 37-37 K and 25-26 K PS-b-PMMA on neutral (random copolymer mat) and preferential (native oxide terminated silicon) wetting substrates.

FIG. 4e schematically illustrates morphologies of a printed BCP thin film before and after annealing and defines geometrical parameters corresponding to the average thickness immediately after printing (t) and the increase in thickness at the edge (δh) due to annealing.

FIG. 4f shows the dependence of δh on t for two BCPs having different MWs.

FIG. 4g shows the dependence of δh on annealing time for two BCPs having different MWs.

FIG. 5a shows a schematic illustration of directed self-assembly (DSA) of a BCP on a chemically patterned substrate.

FIGS. 5b and 5c show SEMS images of defect-free directed assembly of lines of BCP printed on a chemically patterned substrate.

FIG. 5d shows an SEM image of printed lines of BCPs having two different MWs on a chemically patterned substrate.

FIG. 6a shows a schematic illustration of directed self-assembly (DSA) of a BCP on a topographically patterned substrate.

FIGS. 6b and 6c show representative SEM images of directed assembly of printed BCPs within trenches defined on a neutral substrate.

FIGS. 6d and 6e show SEM images of BCP lines printed in the direction parallel to the long axis of a trench for lamella-forming (FIG. 6d) and cylinder-forming (FIG. 6e) BCPs.

FIGS. 6f and 6g show SEM images of BCP inks having two different MWs on a topographically patterned substrate.

FIG. 7a is a schematic illustration of patterning random copolymer brushes by printing.

FIG. 7b is an SEM image of a self-assembled film of PS-b-PMMA (37-b-37) in a region that contains a printed line of the P(S-ran-MMA) brush.

FIG. 7c shows an SEM of a self-assembled BCP on a complex printed random copolymer pattern.

FIG. 7d shows an AFM image of a grafted P(S-ran-MMA) (62S) brush printed in a pattern of concentric circular lines and an SEM image of various magnifications of BCP self-assembled on the pattern.

FIG. 7e shows AFM images of grafted brushes printed in the form of filled pads with different geometries and consistent heights.

FIG. 7f shows SEM images of a self-assembled film of a cylinder forming PS-b-PMMA (46-b-21) on a printed square of P(S-ran-MMA) (62S). A magnified SEM image is given on the right.

FIG. 8a shows an AFM image of an array of printed lines of P(S-ran-MMA) (62S).

FIG. 8b shows an SEM image of a self-assembled PS-b-PMMA (37-b-37) film cast on top of these brushes shown in FIG. 8a.

FIG. 8c shows a high-magnification SEM image of the film shown in FIG. 8b.

FIG. 9 shows SEM images of BCP self-assembly near regions of chemical transitions provided by patterns of random copolymer brushes formed by e-jet printing for two different brush compositions (62-S and 76-S).

FIG. 10a shows an SEM image of an assembled cylinder forming PS-b-PMMA (46-b-21) on top of a brush (62-S) grafted region.

FIG. 10b shows an SEM image of an assembled cylinder-forming PS-b-PMMA (46-b-21) on top of a silicon substrate with a native oxide layer.

FIG. 10c shows an SEM image of an assembled printed cylinder-forming PS-b-PMMA (46-b-21) film near brushes patterned in a vertical stripe geometry.

FIG. 11a is a schematic illustration of a substrate that includes a topographical pattern and a printed brush pattern.

FIG. 11b is a schematic illustration of BCP assembly on the substrate in FIG. 11a.

FIG. 11c is an SEM image of an assembled BCP film on a substrate that includes a topographical pattern and a printed brush pattern.

FIG. 12a is a schematic illustration of a substrate that includes a schematic illustration of a substrate that includes a chemical pattern.

FIG. 12b is a schematic illustration of a substrate that includes a schematic illustration of a substrate that includes a chemical pattern and printed brush pattern.

FIG. 12c is a schematic illustration of an assembled BCP film on the substrate illustrated in FIG. 12b.

### DETAILED DESCRIPTION

One aspect of the subject matter disclosed herein relates to methods of patterning block copolymer (BCP) films with independent control of the size, periodicity and morphology of the resulting nanoscale domains. Also disclosed are BCP patterns having discrete areas of different self-assembled BCP thin films on a surface, the BCP thin films differing in one or more of molecular weight, composition, morphology, and feature size. Direct, additive jet printing and self-assembly of BCP can be used together to form deterministically defined structures in wide-ranging, hierarchical patterns with length scales from centimeters down to about 10 nm. In some implementations, an advantageous feature of this scheme, particularly for envisioned applications in advanced nanolithography, is that multiple BCPs with different MWs or mixtures of MWs can be printed onto a single substrate, thereby providing access to patterns with diverse geometries and feature sizes. The printing approaches can be applied to various BCP chemistries, morphologies and directed self-assembly (DSA) strategies.

Another aspect of the subject matter disclosed herein relates to methods of forming BCP thin films on patterns of polymer brushes formed by electrohydrodynamic printing. The methods involve direct, high resolution electrohydrodynamic delivery of random copolymer brushes as surface wetting layers to control the geometries of nanoscale domains in spin-cast and printed BCPs. Patterns of brushes with complex geometries and feature sizes down to about 50 nm combine with natural processes of self-assembly to provide unusual options in patterning of surfaces at multiple length scales. These approaches may be useful in patterning of top-coat materials on BCP films to provide neutral layers for perpendicular assembly of domains with sub-10 nm dimensions.

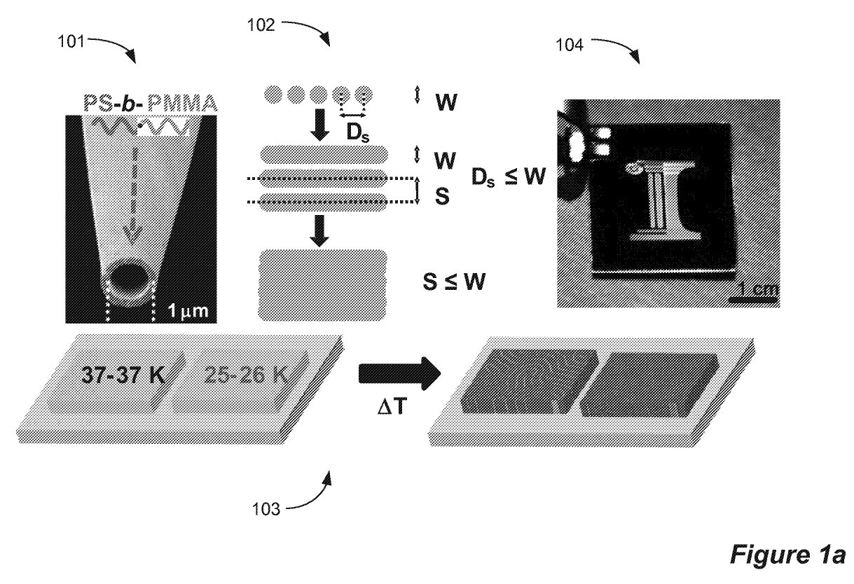

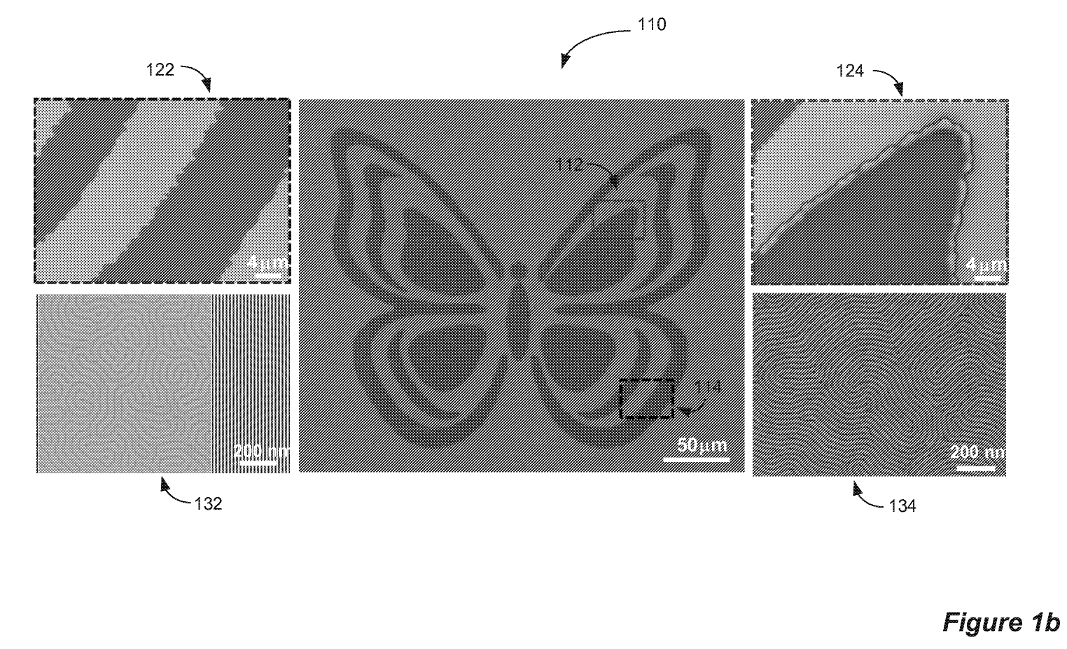

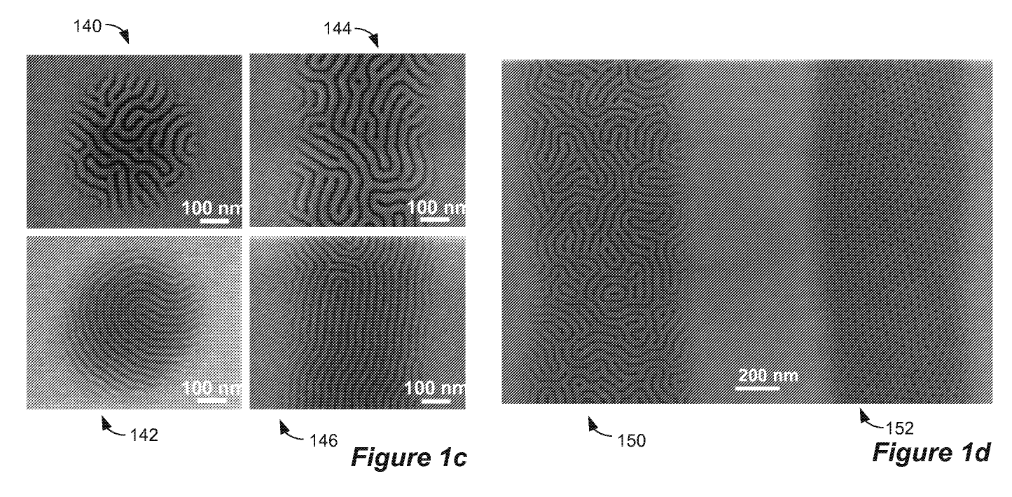

Electrohydrodynamic (e-jet)printing uses electric fields to generate fluid flows to deliver ink to a substrate. An electric field between a nozzle containing an ink and a substrate to which the ink is transferred is established. A voltage pulse can be generated between the substrate and the nozzle, creating a distribution of electrical charge on the ink and causing a flow of ink from the nozzle onto the substrate. The ink may be in the form of discrete droplets (as discussed for example with respect to FIG. 1a below) or a continuous stream.

Described herein is an advanced form of electrohydrodynamic jet printing to define arbitrary patterns of BCP films with independent control of the size, periodicity and morphology of the resulting nanoscale domains, in a manner that does not involve physical contact with the substrate. Here, applied electric fields drive flow of inks from nozzles, to achieve droplet sizes as small as about 100 nm. Multiple nozzles allow rapid and purely additive patterning of multiple ink formulations, with accurate registration. Inks based on BCPs such as poly(styrene-block-methyl methacrylate) (PS-b-PMMA) can be routinely printed as dots and lines with sub-500 nm dimensions, excellent uniformity and repeatability in thickness (roughness <2 nm) and user-defined layouts that span length scales from the sub-micron to centimeter regimes. These procedures define the location, size and geometry of patterns of BCP films in a hierarchical lithography process that naturally capitalizes on nanoscale features that form by self-assembly. Precise control over the architecture and registration of the nanoscale domains of BCPs in each printed region can be achieved by printing onto chemically and topographically templated substrates, via processes of directed self-assembly (DSA).

FIG. 1a shows a schematic example of forming BCPs having different molecular weights (MWs) in discrete areas on a substrate, followed by self-assembly of the BCPs. Because the BCPs have different MWs, the resulting feature sizes are different. Applying a voltage between a grounded substrate and a metal coating on a glass capillary loaded with a BCP-containing ink results in the flow of BCPs through a fine nozzle aperture at the tapered tip. At 101 an example of a fine nozzle aperture having a 1 μm internal diameter is shown. A computerized system of translation stages can be used to move the substrate relative to the nozzle and control the voltage for printing lines or dots in a raster scanning mode. As shown schematically at 102, operation in this mode allows patterns of droplets (W, diameter; Ds, droplet spacing) to define lines (W, width; S, line spacing), and lines to define areas. This procedure yields continuous BCP films with programmed micro and/or nanoscale geometries over macroscopic area in an automated fashion, enabling extremely efficient use of the BCP materials. Thermal annealing results in the self-assembly of BCPs into nanostructures on a neutral substrate (103). The image at 104 provides an example of a large-area pattern formed using 2% 37-37 K PS-b-PMMA and a nozzle with 10 μm internal diameter. In addition to thermal annealing, other techniques such as solvent evaporation may be used to induce self-assembly.

FIG. 1b shows images of multiple BCP inks assembled into a complex layout. A silicon wafer functionalized with a random copolymer mat provided a surface that is non-preferential (i.e. neutral) in wetting towards the PS and PMMA blocks of PS-b-PMMA BCPs. Thermal annealing induces phase separation of the BCPs into domains oriented perpendicular to the substrate surface. Image 110 shows a butterfly patterned with BCPs on the substrate surface, the body and outer wing being printed with a 37-37 K PS-b-PMMA (bulk lamellar period, L₀=41 nm) and the inner wing printed with a 25-26 K (L₀=27 nm).

Images 122 and 132 are high-magnification views of a region. 112 printed 37-37 K PS-b-PMMA and images 124 and 134 are high-magnification views of a region 114 printed with 25-26 K PS-b-PMMA (L₀=27 nm), Periodicity of each assembled BCP is determined by the molecular weight of the BCP, with the domain size of the 37-37 K PS-b-PMMA larger than that of the 25-26 K PS-b-PMMA, as can be seen by comparing images 132 and 134.

FIG. 1c show isolated dots and lines of BCP films in sub-500 nm dimensions: Images 140 and 142 show individual dots (left) printed with 37-37 K (top) and 25-26 K (bottom) PS-b-PMMA images 144 and 146 show individual lines printed with 37-37 K (top) and 25-26 K (bottom) PS-b-PMMA. The ink was 0.1% PS-b-PMMA printed with a nozzle with 500 nm internal diameter.

In some implementations, BCPs having different morphologies are assembled on a substrate. Printing BCPs with different volume fractions allows generation of variety of nanoscale morphologies on the same substrate. FIG. 1d is an image showing self-assembled nanoscale structures with two different morphologies (lamellae forming 37-37 K at 150; cylinder forming 46-21 K, at 152) printed as lines.

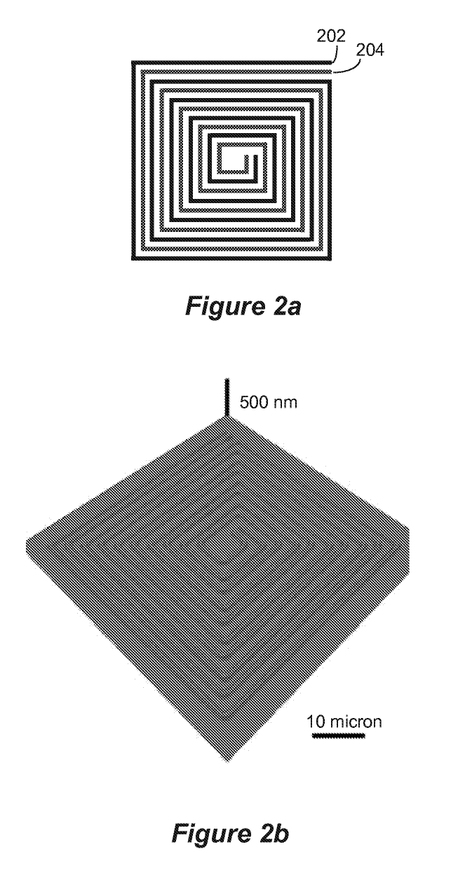

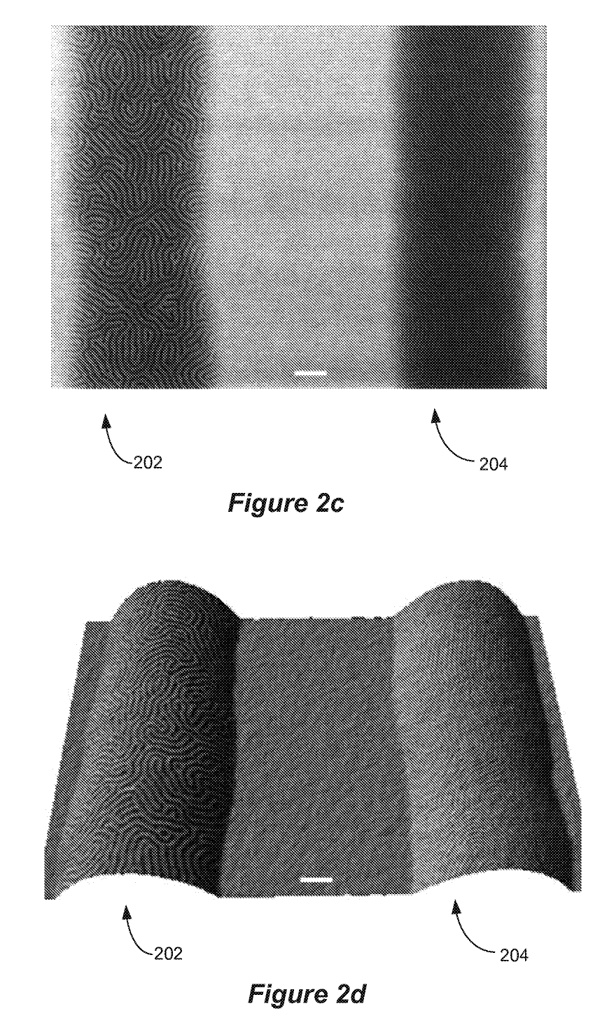

Multiple BCPs are provided on a substrate with highly accurate registration. Registration refers to the relative placement of the different BCPs. The BCPs may also be precisely registered to the underlying substrate, such that each BCP is located at a precise and identifiable location on the substrate. FIG. 2a shows a schematic illustration of a concentric spiral pattern of alternating lines of two different BCPs: PMMA-b-PS of 37-37 K (202) and 25-26 K (204). Adjacent lines have a separation of about 1 μm. FIG. 2b shows an AFM image of the printed pattern, with line widths and spacings of 800 nm and 1 μm, demonstrating successful printing. FIG. 2c shows a high-magnification SEM image of a representative region of the spiral pattern, showing self-assembled nanoscale structures with different periodicities (41 nm for 37-37 K, 202; 27 nm for 25-26 K, 204). A high-magnification AFM image in FIG. 2d includes information from both the amplitude (height) and phase (tip—sample interaction) to illustrate both the topography and the chemical species. The heights of the printed lines at the center are about 40 nm. In another example, square patterns (20×20 μm²) of BCPs with different MWs separated by 3 μm were formed.

The results of FIGS. 2b-2d demonstrate the ability for accurate and uniform registration at the sub-micron level, over large areas. Enhanced operation in this regime, and beyond, can be facilitated by replacing diffraction-limited optical techniques with the type of Moire methods that are successfully applied in conventional and nanoimprint lithography machines.

Programmed printing with multiple passes allows for precise control not only over the lateral dimensions and registration of the printed patterns, but also of their thicknesses. Thickness plays an important role in the orientation of the domains on chemically homogeneous surfaces that result from BCP self-assembly. In particular, the ratio of the thickness to the L₀ can be a critical parameter and may be selected to be some multiple of 0.5. The methods disclosed herein provide repeatable control of the thickness, in a way that does not depend strongly on characteristic lateral feature sizes. Regions of various lateral dimensions may be printed with high repeatability. For example, printed squares of side dimensions 15, 10 and 5 μm, corresponding to areas more than one hundred times smaller than those possible with conventional ink jet techniques, were printed. The thickness uniformity across the films and thickness repeatability were high, both within 2 nm as measured after annealing. In particular, the average and standard deviation in thickness for the 15, 10 and 5 μm films were 26.2 nm, 26.9 nm, 26.1 nm and 1.2 nm, 1.5 nm, 1.6 nm, respectively. Capabilities in thickness control over a range relevant for BCP lithography was demonstrated by printing an array of 25 μm wide squares with thicknesses between 20 nm and 120 nm.

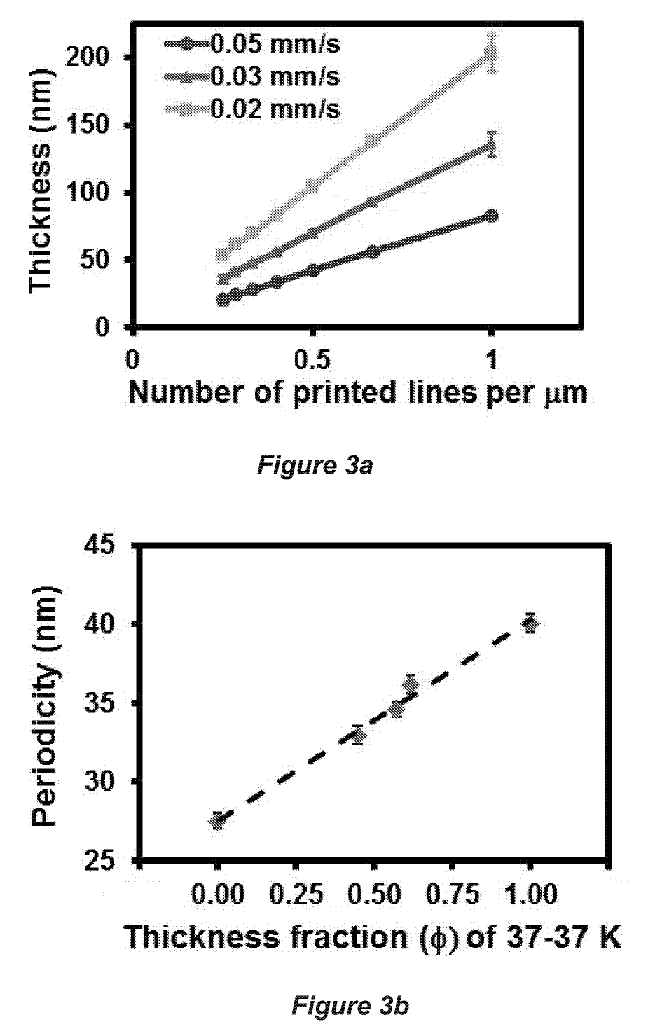

FIG. 3a is an example of a calibration curve showing thickness of printed films as a function of number of printed lines per micrometer (inverse of the spacing between consecutive lines) for various printing speeds. Thicknesses correspond to averages across 50-μm-wide square films printed using a nozzle with 5 μm internal diameter. Error bars indicate variation in the thickness of films across individual squares. A wide range of thicknesses can be accessed through control of other parameters such as the weight percentage of the ink, printing speed, applied voltage and standoff height. For a given ink formulation and set of printing conditions, the most straightforward means to adjust the thickness is through the spacing between adjacent printed lines. Here, lateral flow during annealing leads to uniform thicknesses that depend linearly on the inverse of the spacing.

When taken together with registration control, this ability to print well-defined amounts of BCPs provides an opportunity to mix two (or more) BCPs with different MWs, at specific relative concentrations, on the substrate surface. This capability enables continuous tuning of the periodicities of the nanoscale domains, defined at the printing step. FIG. 3b shows the periodicity of BCP domains as a function of thickness fraction of 37-37 K PS-b-PMMA in a binary mixture with 25-26 K PS-b-PMMA. The intimate mixing that occurs during printing and subsequent thermal annealing leads to nanoscale domains with periodicities that are in between the natural values set by the MWs of the BCP. The mixtures were obtained by sequentially printing 20-μm-wide square films on top of each other. The 37-37 K BCP was printed first. Annealing at 220°60 C. for 5 min followed printing of both BCPs. Periodicities were calculated through the use of an image analysis algorithm. Error bars indicate standard deviation in the average periodicities measured at different locations.

For squares with the same size, the relative ratio of the two copolymers is determined by the thickness of each printed film. Referring to FIG. 3b, the periodicity of nanoscale domains in the mixtures shows a simple linear dependence on the fraction of the individual BCP present on the surface. This dependence agrees well with a previously reported scaling relationship, which approximates the linearity for BCP blends of similar MWs mixed in solution. This approach to tuning the periodicity has significant practical value because it enables a simple printer system, capable of patterning only two inks, to access a continuously adjustable range of nanoscale feature sizes. Selection of the BCP inks for mixing should account for the miscibility range for disparate molecular weight BCPs.

Concepts of mixing can also be applied to different volume fraction BCPs or corresponding homopolymers to generate a variety of different morphologies on a single substrate. For example, a region of a lamellar-forming BCP may be printed on a region of a cylindrical-forming BCP to generate a thin film having a more complex morphology. According to various implementations, the size and shape of sequentially printed BCPs may be the same or different. For example, one or more of periodicity, morphology, film composition, etc., may be continuously tuned across a substrate.

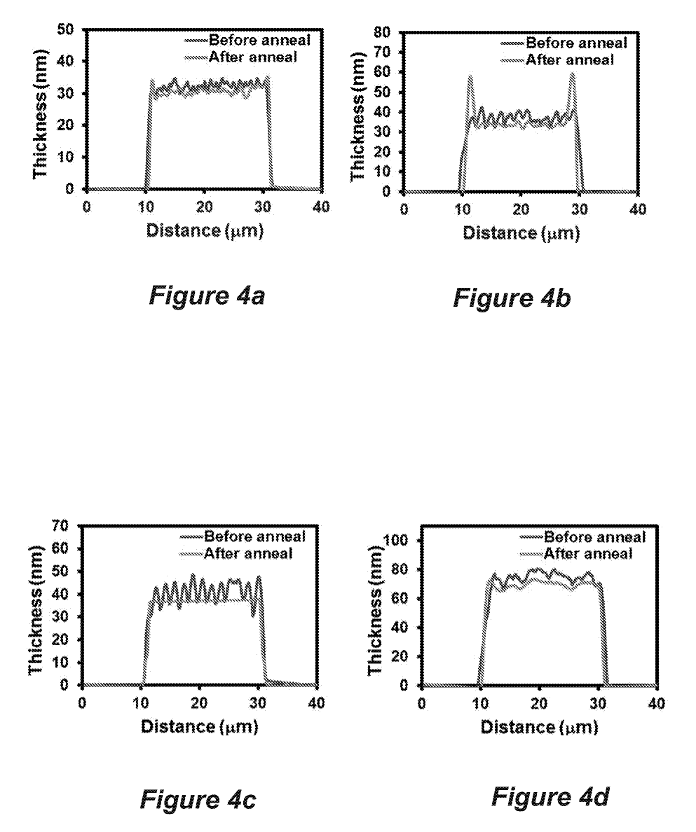

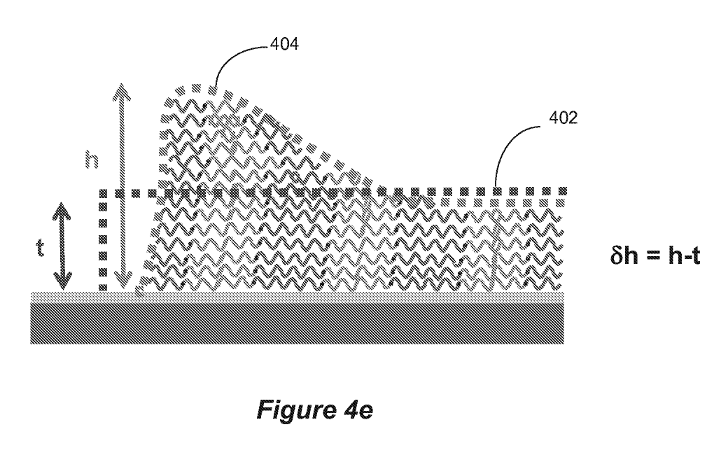

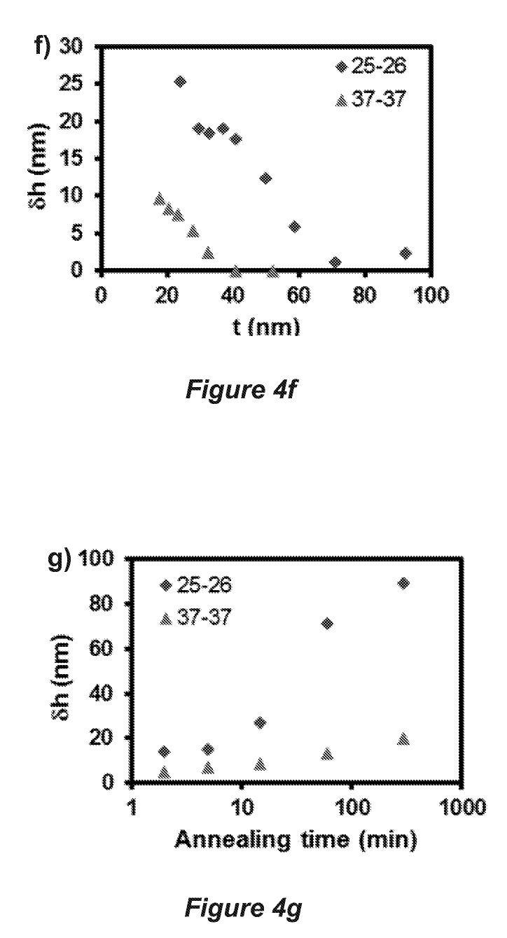

The processes of film formation and self-assembly depend strongly on wetting and flow behaviors during annealing. Effects related to MW, substrate functionality and thickness emerge from systematic studies of height profiles of printed patterns of PS-b-PMMA evaluated immediately after printing and subsequent annealing at 220°60 C. for 5 min. A series of 20 μm wide square films with varying thicknesses printed using 37-37 K and 25-26 K PS-b-PMMA on neutral (random copolymer mat) and preferential (native oxide terminated silicon) wetting substrates serve as the basis of the investigations. FIGS. 4a-4d show cross-sectional height profiles of several examples Annealing an approximately 30 nm thick film of 37-37 K PS-b-PMMA on a neutral substrate leads to a slight decrease in the roughness without a significant change in the height profile (FIG. 4a). By contrast, otherwise similar experiments with 25-26 K PS-b-PMMA (FIG. 4b) indicate that material near the edges retracts to form a local region with thickness that is about 30 nm larger than the rest of the film. In addition to this dependence on MW, the wetting properties of the substrate are also important. For example, a printed film of 25-26 K PS-b-PMMA on a preferential wetting substrate (FIG. 4c) leads to narrow perimeter regions with the thicknesses of one layer (0.5 L₀), and a large central region that has a thicknesses of exactly L₀. The perfect flatness of the surface after anneal results from a match between the thickness of the printed film and L₀, which corresponds to complete layers of the PMMA and PS blocks at the substrate and air interface, respectively. If the thickness is incommensurate with L₀, then islands/holes may form, in a manner analogous to related behaviors observed in spin-cast BCP films. Films printed on preferential wetting substrates may also exhibit narrow terrace regions forming at the edges. This phenomenon is unique to the 3D confined nature of printed patterns and is consistent with observations in the edges of spin-cast films and randomly deposited BCP droplets.

Another consideration arises from effects of thickness. For example, as the thickness of a printed film of 25-26 K PS-b-PMMA increases from about 30 nm (FIG. 4b) to about 70 nm (FIG. 4d), the edge effects diminish significantly. The effect of annealing can also be clearly observed on printed lines. Here, the width decreases and the thickness at the center increases with annealing on neutral wetting substrates. Collectively, these results indicate that the thickness uniformity improves as the MW, the thickness and strength of wetting interactions with the substrate increase.

Quantitative analysis of results obtained on neutral substrates provides additional insights. FIG. 4e schematically illustrates the morphologies before (402) and after (404) annealing, and defines key geometrical parameters, where t and δh correspond to the average thickness immediately after printing (t) and the increase in thickness at the edge (δh) due to annealing. FIG. 4f shows the dependence of δh on t for two different MWs. Consistent with findings described above, the results indicate that the edge effects diminish with increasing thickness and MW. Additionally, δh increases with the annealing time (FIG. 4g). An inference is that dewetting of PS-b-PMMA chains on neutral substrates plays a crucial role in determining the final thickness profile. Given the perpendicular orientation of assembled domains with respect to the substrate across the entire printed areas, including the edges, one interpretation is that PS and PMMA chains locally face methyl methacrylate and styrene monomers of the random copolymer mat, respectively. As such, both blocks prefer to minimize contact with the substrate. With sufficient mobility (i.e. low MW, long annealing times), motion occurs at the edges of the films to increase the local thickness. In spite of these diverse, coupled effects, the data of FIGS. 4f and 4g indicate that highly uniform films are possible at certain thickness and annealing conditions. This capability is important for practical applications.

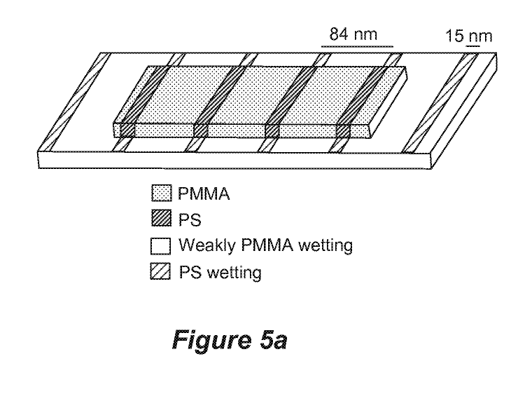

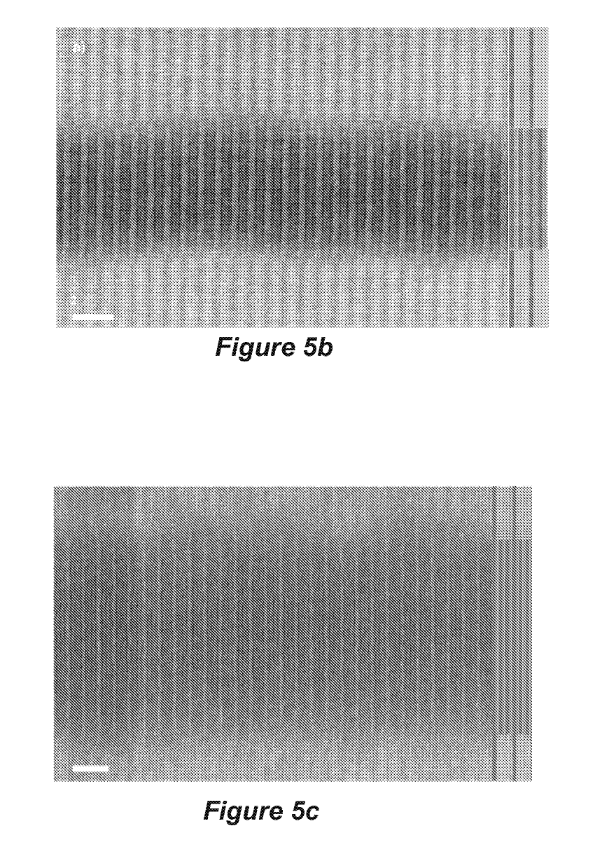

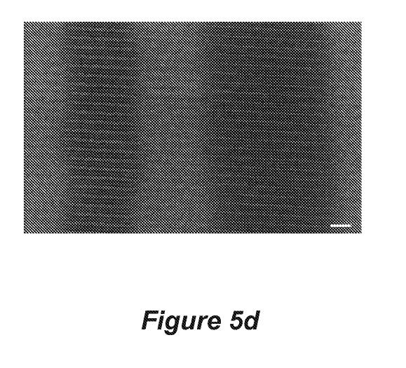

Many applications require pattern perfection and precise registration in the architecture of the BCP domains within each printed region. The printing schemes described here are compatible with DSA techniques that use both chemically and topographically patterned substrates. FIG. 5a shows an example of the former, where the substrate presents guiding stripes of PS mats spaced by regions functionalized with a random copolymer brush to minimize the interfacial energy of lamellae-forming BCP films with perpendicularly oriented domains registered to the guiding stripes. The periodicity of these stripes, which are about 15 nm wide, is 84 nm, corresponding to two and three times the value of L₀ for the 37-37 K and 25-26 K PS-b-PMMA inks, respectively. FIGS. 5b and 5c show results of defect-free directed assembly of lines of BCP printed onto this type of substrate. One in every two (FIG. 5b; 37-37 K) and three (FIG. 5c; 25-26 K) of the PS domains appears brighter in these images, due to differences in the chemistry of the underlying patterns, as observed directly in the regions without printed BCPs. As a demonstration of DSA with multiple periodicities on the same substrate, FIG. 5d presents an SEM image of printed lines of BCPs with two different MWs. The results demonstrate successful DSA of nanoscale domains with two different periodicities on exactly the same chemical pattern. DSA of BCP films of discrete sizes was also performed with defect-free alignment of the domains with respect to the underlying chemical pattern.

The wetting behavior of BCP films printed on neutral and chemical patterned substrates is different. For example, edge effects after annealing are minimal for thin (about 20 nm) printed films of 25-26 K on chemical patterns. Such effects are consistent with behavior that lies between that of preferential and neutral substrates. One explanation is that the PS stripes pin the PS domains of the BCP, thereby preventing movement at the edges of the film, similar to the case with preferential wetting.

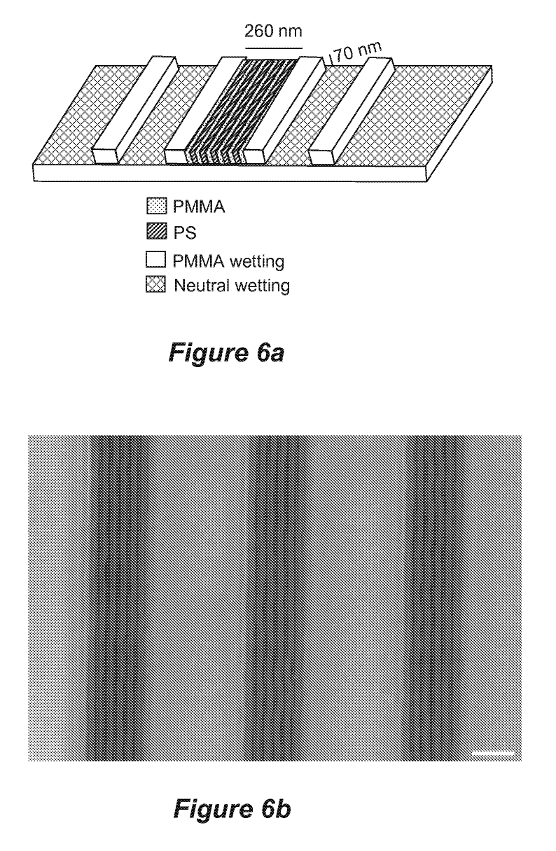

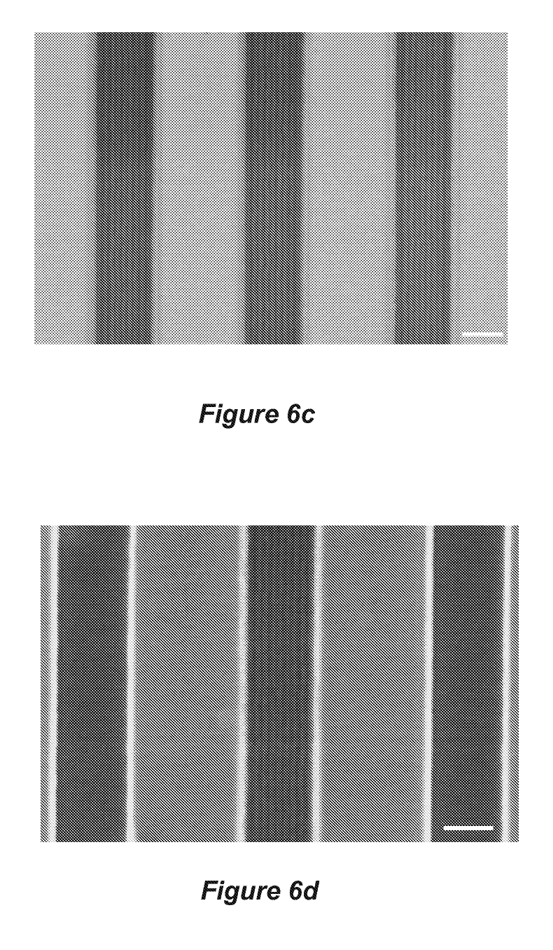

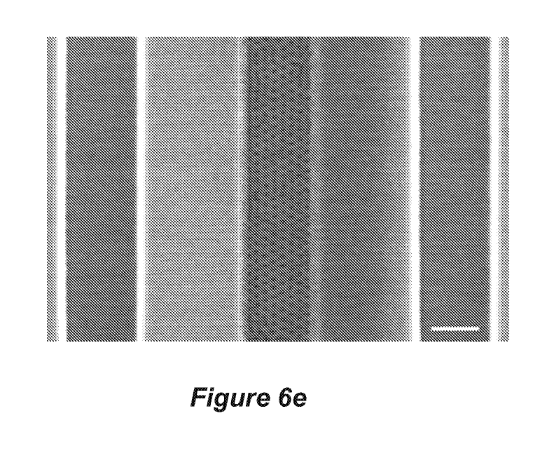

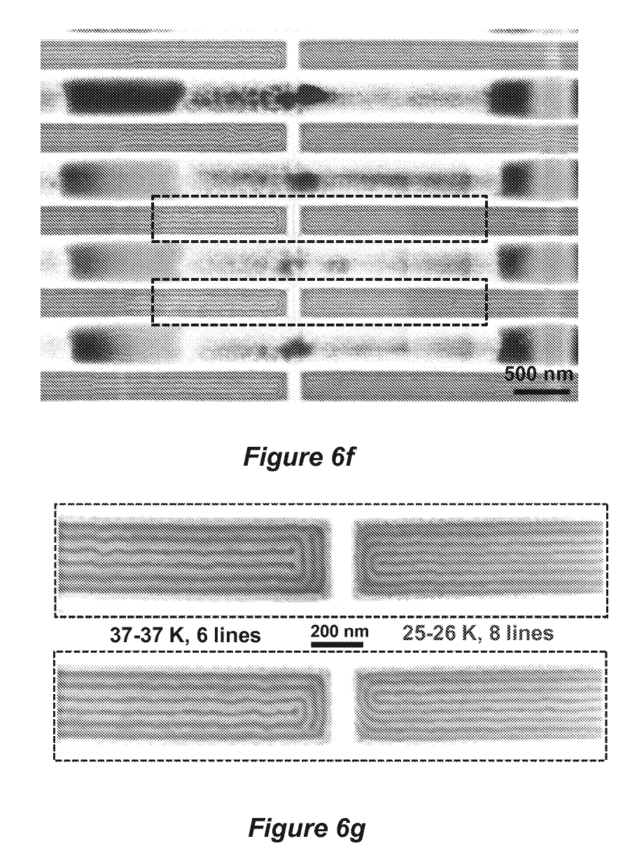

Compatibility of printing with DSA based on surface topography, i.e. graphoepitaxy. FIG. 6a shows a schematic illustration of BCP assembly in a trench. In this case, the substrate presents topographical (about 70 nm deep) features of lines of hydrosilsequioxane (HSQ; about 70 nm thick and about 260 nm wide) patterned by electron beam lithography on a neutral substrate. The PMMA block preferentially wets the HSQ sidewall of the trenches; the bottoms of the trenches are neutral. Under these boundary conditions, the lamellar BCP domains orient perpendicular to the substrate and exhibit a high level of orientational alignment along the axis of the trenches. FIGS. 6b and 6c show representative images of directed assembly of printed PS-b-PMMA BCPs within 70 nm deep, 260 nm wide trenches defined on a neutral substrate. A BCP with a MW of 37-37 K is shown in FIG. 6b and a BCP with a MW of 25-26 K is shown in FIG. 6c.

The effects of DSA and graphoepitaxy are clearly observable near the sidewalls that face away from the patterned regions. Here, favored interactions between the PMMA block and the HSQ results in movement of BCPs from microns away to the central axis of the line. A unique capability is printing lines along the long axis of the trench to selectively fill these areas with BCPs, for directed assembly. FIG. 6d shows an image of BCP lines printed in the direction parallel to the long axis of the trench for lamella-forming 25-26 K PS-b-PMMA. FIG. 6e shows an image of BCP lines printed in the direction parallel to the long axis of the trench for cylinder-forming 46-21 K PS-b-PMMA. In both FIGS. 6d and 6e, only the central trench is filled with BCPs. Printing a cylinder-forming BCP as in FIG. 6e allows the generation of guided arrays of dots in selected trenches. The results demonstrate applicability of the approach to a range of complex geometries that may be needed in the integrated circuit lay-outs.

Use of BCP inks with two different MWs enables domain structures that have two different periodicities within the same trench or trench area, as shown in FIGS. 6f and 6g. FIG. 6f is an SEM image showing the directed assembly of BCPs with MWs of 37-37 K (left) and 25-26 (right) in adjacent trenches. The dark structures on top of the HSQ correspond to residual BCP. FIG. 6g is a high magnification view of the image in FIG. 6f. Whereas templates for DSA using chemical patterns are optimum when the period of the chemical pattern is an integral multiple of the different period BCPs that are printed, templates for DSA using topographic patterns are substantially more forgiving with respect to commensurability constraints and can be used with a wide range of BCPs to create patterns with different periods in a single layer.

Another aspect of the disclosure is an additive scheme that uses electrohydrodynamically induced flows of liquids to pattern well-defined surface wetting layers. The methods and resulting wetting layers may be used in DSA of BCPs including printed BCPs (as described above) and spin-casted BCPs, as well as for any application in which a well-defined wetting layer is desired.

As discussed above, BCPs can self-assemble to form dense, nanoscale patterns suitable for use as templates for applications in nanolithography, membrane technology, electronic devices, and metamaterials. Interfacial interactions determine the orientations of the domains that result from this type of assembly when it occurs in thin film geometries. For lithographic applications, nanoscale domains with orientations perpendicular to the substrate surface can serve as resists for the transfer of patterns to the underlying substrate. One approach to engineer the proper orientation involves control of the wetting behavior of the substrate through surface grafting of random copolymer brushes that include monomers present in the BCP. The composition of the brushes defines either preferential or non-preferential interactions with the blocks of the copolymer. The latter leads to assembly of domains with orientations perpendicular to the substrate. Surfaces also play critical roles in the DSA of BCPs, where topographically or chemically patterned substrates exert significant influence on the morphologies of the nanoscale domains. In both cases, deposition of wetting layers typically involves spin-casting, to form uniform, unpatterned coatings. Most applications of BCPs demand fine spatial control of surface interactions across length scales that range from tens of nanometers to centimeters. Conventional lithographic techniques can be used to remove uniform brush coatings in regions not protected by a resist or to define patterns of cross-linked polymer mats to prevent brush grafting in selected regions. These methods involve, however, multiple process steps and sacrificial layers that can cause difficulties in forming pristine surfaces or patterns that incorporate more than a single brush chemistry. Described herein are methods that offer purely additive operation, nanoscale resolution, large-area compatibility, and capacity to directly pattern materials in a way that preserves their chemistry and leaves unpatterned surfaces in an unmodified state. Such capabilities are important not only for developing advanced methods in BCP-based nanofabrication, but also for fabricating test structures in fundamental studies of self-assembly.

One aspect is an additive scheme that uses electrohydrodynamically induced flows of liquids through fine nozzle tips to pattern well-defined surface wetting layers. The method, sometimes referred to as e-jet printing, enables directed delivery of end-functional random copolymers with different compositions of random copolymers to target surfaces in well-defined layouts. For example, random copolymers having different compositions of styrene and methyl methacrylate, P(S-ran-MMA), may be used. The resulting patterns dictate self-assembly processes in BCPs of PS-b-PMMA. The additive nature of e-jet printing defines pristine chemical surfaces, in arbitrary geometries at length scales (about 100 nm) sufficiently small to induce highly aligned arrays of self-assembled nanoscale domains. E-jet printing offers three unique and useful capabilities for control of phase behavior in BCPs. First, the purely additive operation preserves the chemistry of the printed materials and can leave unpatterned surfaces in a completely unmodified, pristine state. As a result, multiple brush chemistries can be exploited on a single substrate. Second, the jetting process allows delivery of brushes onto lithographically defined templates with significant surface topography, with important consequences in DSA. Third, the method offers options in combined patterning of brushes and BCPs as routes to engineered assemblies with unusual morphologies, chemistries and sizes on a single substrate.

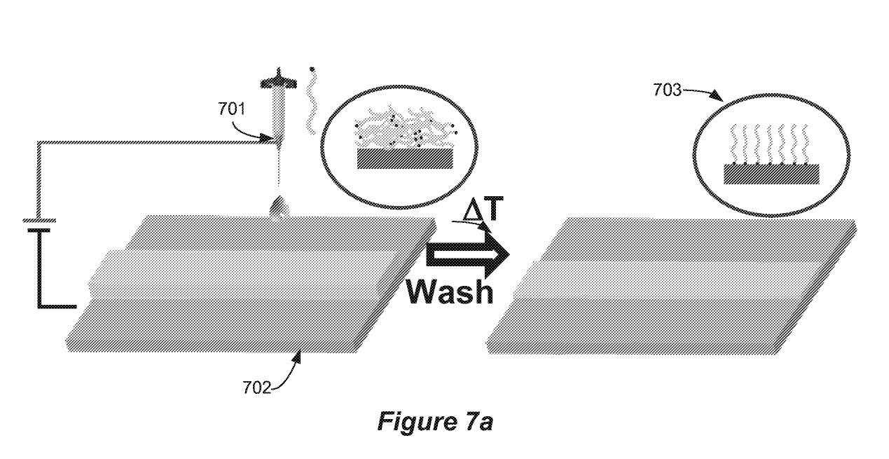

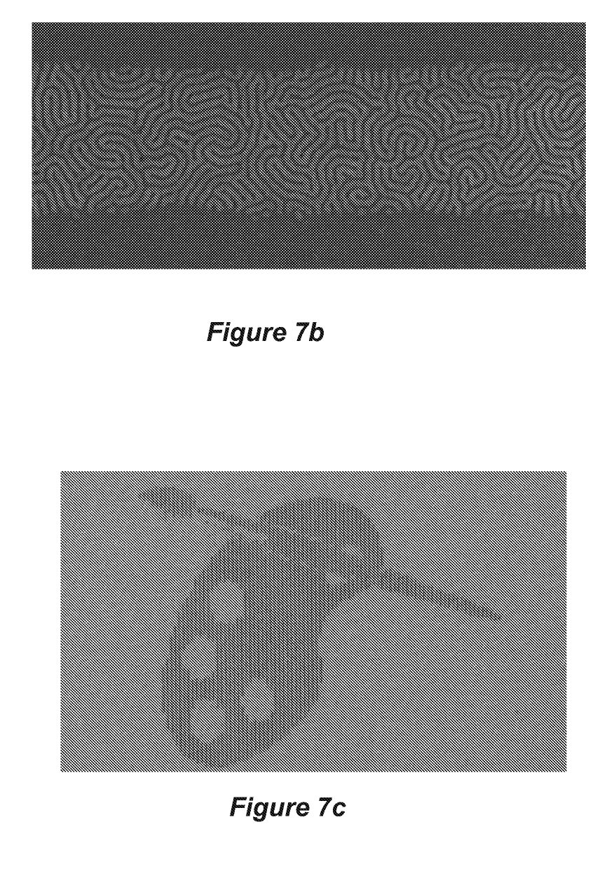

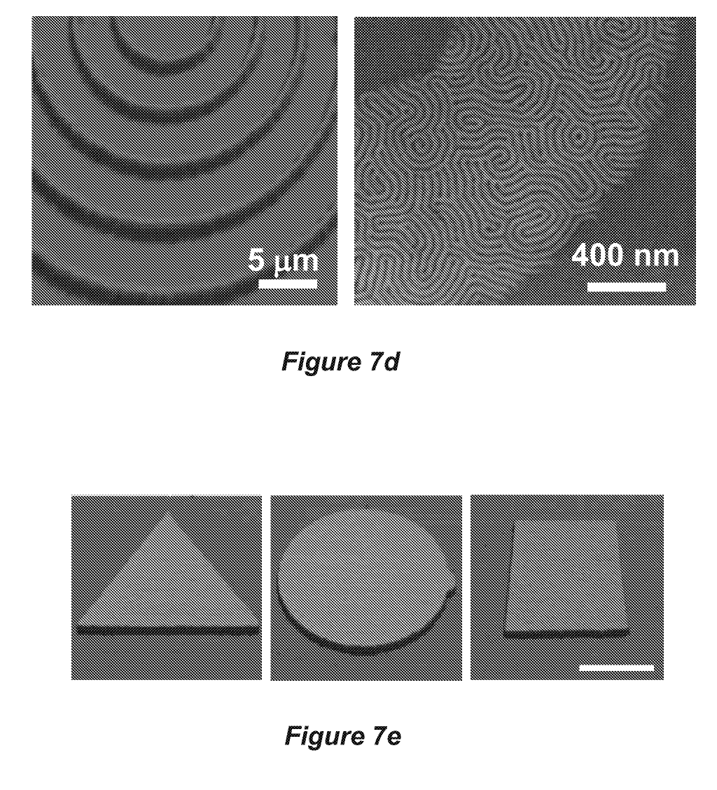

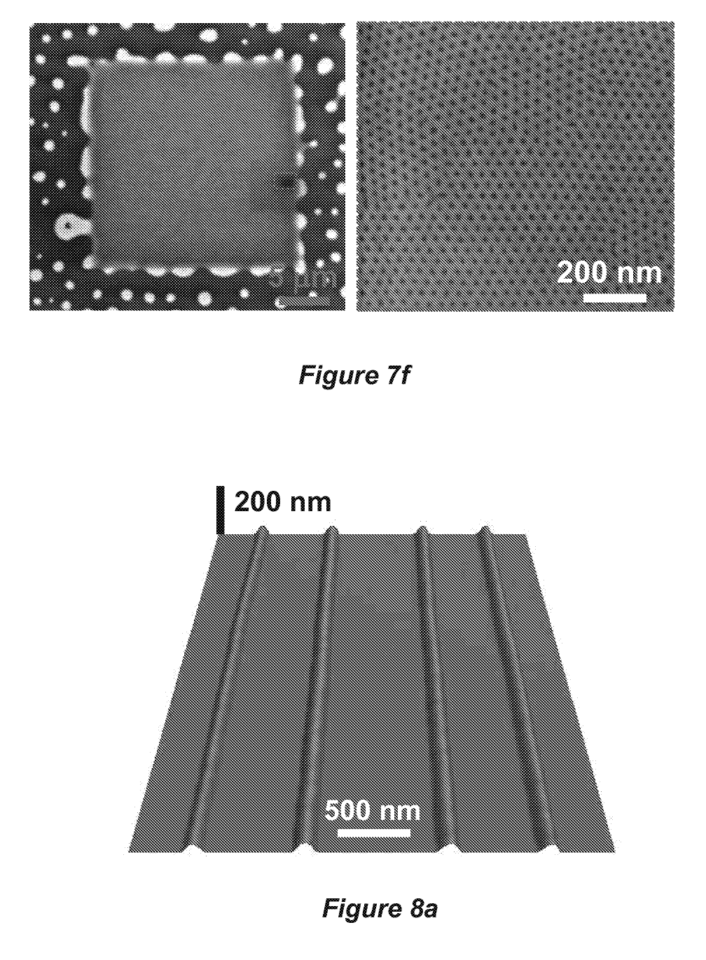

FIG. 7a is a schematic illustration of patterning random copolymer brushes by e-jet printing. Applying a voltage between a metal coated glass capillary nozzle 701 (1 μm internal diameter) and a freshly cleaned silicon wafer initiates controlled, pulsatile flow of inks of P(S-ran-MMA) dissolved in an organic solvent through the nozzle tip. Movement of a stage 702 on which the wafer sits relative to the nozzle yields patterns of brushes in user-defined layouts. A brief thermal annealing step initiates surface condensation reactions between the hydroxyl terminus of the polymer and the silanol groups of the substrate. Washing away the unreacted material leaves covalently bound polymer brushes as shown in inset 703. Height profiles of printed lines evaluated after each operation offer insights. The example here involves a line with a width of about 1 μm and a thickness of about 50 nm at the center. Thermal annealing results in a slight increase of the width and decrease in the height at the center of the line, likely due to thermally induced flow. Limiting the total amount of the printed material suppresses these flows and provides an additional means to control the width. The minimal degree of spreading can be reduced even further through optimization of the annealing conditions. Removing the ungrafted materials by sonication yields patterned brushes with uniform thicknesses of about 10 nm. The effects of annealing and washing can also be observed in discrete geometries such as squares. The functionality of the brushes was assessed using spin-cast and thermally annealed films of a lamellae-forming BCP. Results indicate that the domains form with orientations perpendicular to the substrate in regions of printed P(S-ran-MMA) (62% S and 38% M, 62S). FIG. 7b is an SEM image of a self-assembled film of PS-b-PMMA (37-b-37) in a region that contains a printed line of the P(S-ran-MMA) brush. The featureless regions in the unpatterned areas imply parallel assembly, in a stacked configuration with poly(methyl methacrylate) facing the surface of the substrate.

Diverse pattern geometries are possible, as illustrated in FIGS. 7c-7f. FIG. 7c shows an example of a complex layout that can be defined using computer numerical control commands (e.g., G-code) generated directly from an image of the desired pattern. Advanced setups enable patterns in arbitrary curvilinear forms, as demonstrated by a series of concentric circular lines shown in FIG. 7d, which shows an AFM image of a grafted P(S-ran-MMA) (62S) brush printed in a pattern of concentric circular lines and an SEM image of various magnifications of BCP self-assembled on the pattern. The radius of curvature can be sufficiently small (e.g., 1 μm) to observe perpendicular orientation of BCP domains in the curved regions, within the limits of the imaging techniques.

The brushes can also be designed in the form of filled polygons with sharp edges, as shown in FIG. 7e. The extreme uniformity in thickness and the low surface roughness (<0.5 nm) follow from the molecular processes and surface chemical bonding that define the height, as well as the high level of control in materials delivery provided by the e-jet approach. The influence of these features on the self-assembly of BCPs can be observed by spin coating a film of cylinder forming PS-b-PMMA (46-b-21 kg/mol) on top of the patterned substrate. FIG. 7f shows SEM images of a self-assembled film of a cylinder forming PS-b-PMMA (46-b-21) on a printed square of P(S-ran-MMA) (62S). A magnified SEM image is given on the right. Thermal annealing leads to island-hole structures in the unprinted regions as a result of the incommensurate thickness of the film with respect to the bulk periodicity of the BCP. The grafted brush changes the wetting behavior from preferential to non-preferential, thereby preventing the formation of such structures and instead forcing perpendicular assembly of BCP domains.

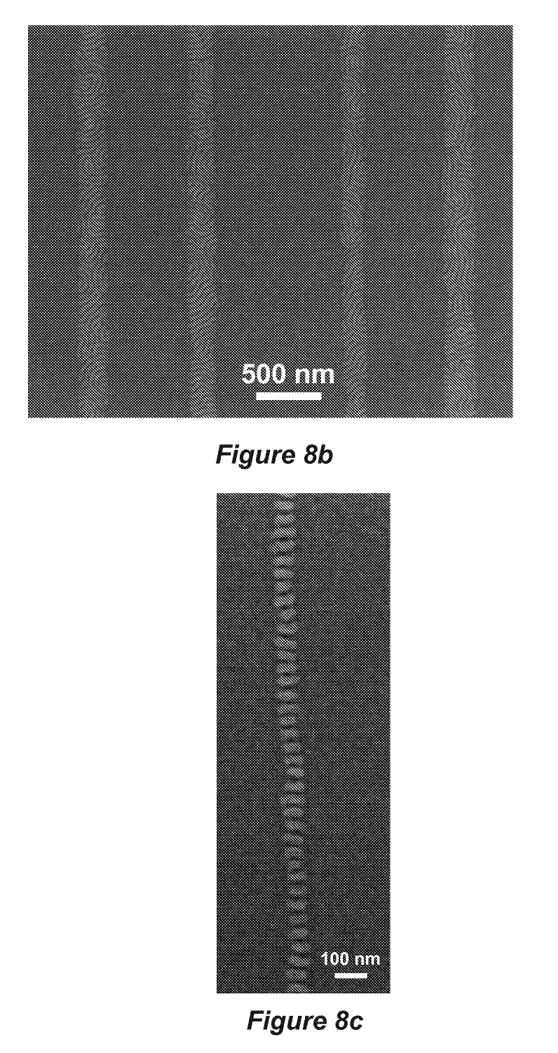

The ability to generate patterned surface polymer interactions at length scales that approach the sizes of individual domains offers an ability to directly influence the self-assembly processes. Nanoscale chemical patterns can induce alignment of BCP domains in registration with the underlying patterns. To realize the nanoscale dimensions, an advanced form of e-jet printing can be used in which fibrous polymer structures, rather than isolated droplets, emerge from the nozzle. This regime of operation, which can be considered as a ‘near field’ type of electrospinning, can yield aligned structures when implemented with fast motion of the substrate. This approach yields arrays of nanoscale lines of P(S-ran-MMA) with dimensions that are much smaller than the size of the nozzle. FIGS. 8a-8c provide examples of high resolution lines of random copolymer brushes formed by e-jet printing, operated in a near-field electrospinning mode. First, FIG. 8a shows an AFM image of an array of printed lines of P(S-ran-MMA) (62S). The resulting chemical patterns provide controlled polymer surface interactions for perpendicular assembly of PS-b-PMMA domains. This can be seen in FIGS. 8b and 8c, which show SEM images of different magnifications of a self-assembled PS-b-PMMA (37-b-37) film cast on top of these brushes shown in FIG. 8a. The result illustrates a remarkable level of alignment in the nanoscale domains. The size of nozzle, concentration of the BCP in the ink and the printing parameters (e.g., voltage and working distance) can be varied to allow patterns of brushes with sub-100 nm dimensions, as shown in FIG. 8c. The smallest line widths (about 50 nm) are a couple of times larger than the periodicity of the phase separated structures in the BCP. However, the resolution demonstrated in FIG. 8c does not represent a fundamental limit, with smaller line widths obtainable by adjusting the nozzle geometries, the accuracy of the electro-mechanical systems and the properties of the inks Here, highly aligned nanoscale domains form along the entire lengths of the lines and fully across their widths. Related self-alignment effects, over much smaller areas, are possible in chemical patterns formed by electron beam lithography.

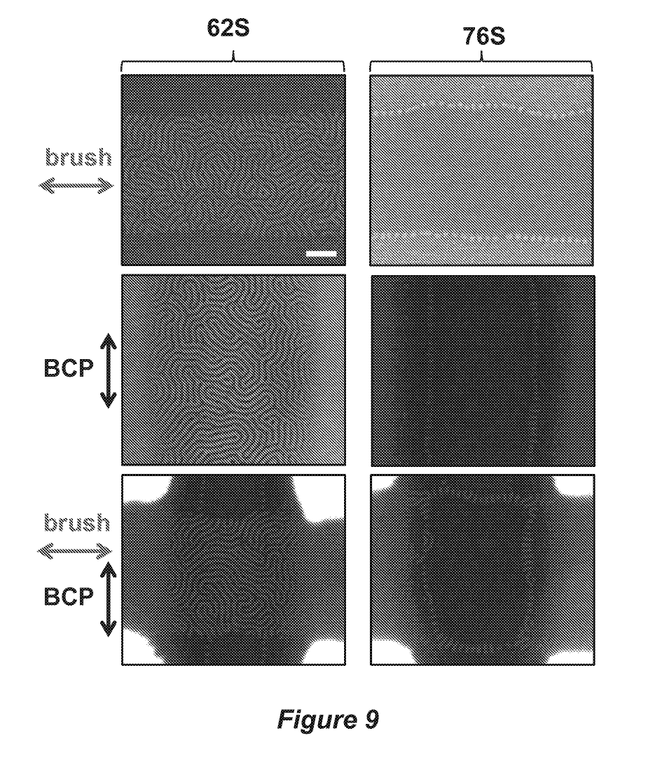

Brushes delivered to surfaces by e-jet printing yield sharp interfaces, with abrupt transitions in the chemistry of the substrate surface. The result induces assembly of BCPs into unique nanoscale morphologies near the edges of the patterned features. Systematic experimental and simulation studies illuminate the effects on the assembly of lamellae forming PS-b-PMMA BCPs spin-cast and printed on top of patterned stripes of brushes on a silicon substrate. The investigations exploit two types of P(S-ran-MMA) brushes, for non-preferential (62-S) and PS preferential (76-S) interactions. FIG. 9 shows SEM images of BCP self-assembly near regions of chemical transitions provided by patterns of random copolymer brushes formed by e-jet printing for two different brush compositions (62-S and 76-S). The top row of FIG. 9 shows a spin-cast film (about 35 nm) of PS-b-PMMA (37-b-37) assembled on top of the patterned brushes in a horizontal stripe geometry; the middle row, a printed line of PS-b-PMMA (37-b-37) assembled on top of the homogenous brush grafted region; and the bottom row, a printed line of PS-b-PMMA (37-b-37) assembled on top of the patterned brushes in a horizontal stripe geometry. The thickness of the printed BCP line at the center is about 40 nm. The scale bar is 200 nm for the SEM images.

Referring to the top row of FIG. 9, assembly of a film of PS-b-PMMA spin-cast on top of printed brushes is shown. Domains assemble parallel to the substrate in the unpatterned regions due to the strongly preferential interactions of the PMMA block with the silicon. By contrast, on 62-S, domains assemble in perpendicular orientations across the entire printed region, with almost equal presence of PS and PMMA domains near the edges. The arrangement of domains predicted by simulations agrees well with the experiments. The copolymer grains on and near the patterned brushes meet at the edge and configure themselves in a manner that minimizes interfacial area. In this case, the geometry satisfies Scherk's first minimal surface. Therefore, perpendicular domains tend to also align perpendicular to the edge, which explains the equal presence of PS and PMMA domains. Thus, the creation of this minimal surface breaks the rotational symmetry in the plane and a preferred orientation is selected, which should induce the formation of well aligned perpendicular lamellae along the axis of the printed brush line. Defects, however, frustrate realization of this perfect morphology. Decreasing the width of the non-preferential region diminishes the role of such defects, thereby improving the alignment, as shown in FIGS. 8b and 8c. On 76-S in the top row of FIG. 9, PS preferential interactions lead to lamellae with parallel orientation, except the edges where the domains appear to assemble perpendicular to the substrate with an interesting one-dimensional arrangement. The simulations accurately predict these results and also capture the full three-dimensional structure of the BCP film, where perpendicular features are found to localize near the top interface of the film. This behavior is a consequence of screw dislocations that arise from the shift between parallel layers at the edge, and the chain connectivity that yields a periodicity in those features along the edge. In both brush compositions (62-S and 76-S), the generation of boundaries between “grains” leads to continuous polymer domains.

Departing from the classical spin-casted BCP films, the use of e-jet printing as described above with respect to FIGS. 1-7f to deposit BCPs in a linear geometry leads to additional types of morphologies on and near the patterned brushes (FIG. 9, top and middle rows). The orientation of domains is perpendicular through the printed line on patterned 62-S, as observed with spin-coated BCP films. On the other hand, mixed types of morphologies appear near the edges for the PS preferential (76-S) brush patterns. A narrow terrace like region is also present near the edges for the printed BCP on preferential wetting substrates. These types of morphologies are likely to result from abrupt changes in the chemistry of the brushes as well as variations in thickness along the width of the printed BCP line. Thickness is known to be important in the assembly of BCPs on weakly preferential substrates. The importance of the thickness in such 3-D films is further supported by the observation of different morphologies across the width of BCP nanostructures deposited with an AFM tip. Additionally, thickness gradients across the width of the printed BCP lines may also play a role in the determination of morphologies.

Simulations indicate that surface energies play a key role in the morphologies of printed BCPs on and near the printed brushes. Contrary to typical DSA studies where the surface energies of the substrate and the BCP material (in case of blocks with similar surface tension) are not relevant to the process, here they are crucial in defining the equilibrium morphology. The interplay of 3-D soft confinement, configurational chain entropy and, interfacial and surface energies can result in the selection of a specific orientation (self-alignment) or in more complex morphologies unexpected from the BCP phase diagram in the bulk. The high surface energies associated with both the substrate and the BCP lead to a very low contact angles for the BCP. Simulation results for a line of BCP printed on a homogenous brush agree with the experimental observations. On 62-S, the domains assemble perpendicular to the substrate over the entire printed BCP line. Furthermore, the low contact angle of the BCP line leads to preferential alignment with the interface of BCP domains perpendicular to the edge, but defects prevent the formation of long-range order. This breaking of symmetry arises from the balance of the factors mentioned above; in particular, under low contact angle constraint, other chain orientations involve bending of interfaces and/or chain stretching, none being compensated by other terms in the free energy, therefore yielding non-stable configurations. On 76-S, domains orient parallel to the substrate in the central regions of the BCP line. This orientation is unfavorable, however, near the edges due to the large chain stretching and entropic penalties that result. The domains therefore prefer to orient perpendicular to the substrate at the edge in spite of an enthalpic cost. For BCP lines printed on patterned stripes of brushes (FIG. 9, bottom row), the BCP interacts with both the bare substrate (PMMA preferential) and the non-preferential or PS preferential regions. The SEM images in FIG. 9 show that the domains orient parallel to the bare substrate with perpendicular domains at the edges due to the low contact angle of the BCP. On top of the non-preferential brush, the orientation of domains is similar to that of the BCP line printed onto a substrate with a homogenous brush. On the PS-preferential brush stripe, the low contact angle constraint and the screw dislocations at the “grain boundary” produce a series of perpendicular decorations along the edges.

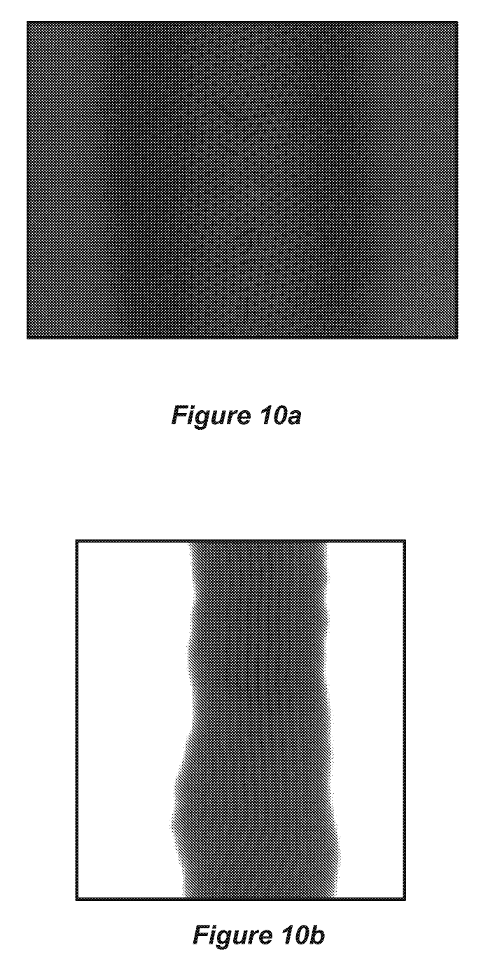

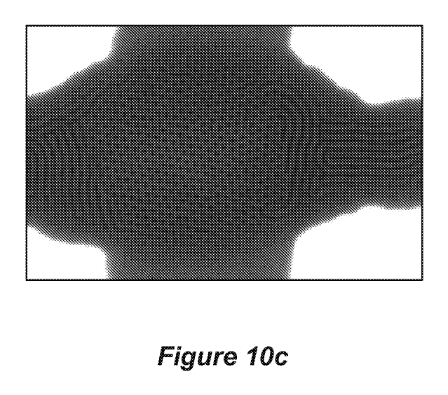

E-jet printed BCPs with cylindrical morphology reveal unique features including self-alignment effects on and near printed patterns of brushes. FIGS. 10a-10c show self-alignment of printed patterns of a cylinder-forming BCP on and near printed patterns of brushes. FIG. 10a shows an SEM image of the assembled cylinder forming PS-b-PMMA (46-b-21) on top of the brush (62-S) grafted region while FIG. 10b shows an SEM image of the assembled cylinder-forming PS-b-PMMA (46-b-21) on top of a silicon substrate with a native oxide layer. FIG. 10c shows an SEM image of the assembled, printed BCP film near brushes patterned in a vertical stripe geometry. The scale bar in the images is 200 nm.

The asymmetric composition of a cylinder forming PS-b-PMMA (46-b-21) leads to an interesting arrangement of domains near the edges of the printed BCPs and brushes. While perpendicularly oriented cylinders occur along the printed BCPs on a non-preferential brush (FIG. 10a), mixed (parallel and perpendicular cylinders) morphologies appear on and near the edges of PS or PMMA preferential regions. Simulation results suggest that the thickness plays an important role on the printed cylinder forming BCPs: in particular, a transition from parallel to perpendicular occurs as the thickness increases. A particularly interesting effect observed in many cases is self-alignment of the domains parallel to the long axis of the printed BCP line on the PMMA preferential wetting bare Si substrate (FIG. 10b). When these domains approach a patterned stripe of a non-preferential brush, the direction of alignment changes from parallel to perpendicular with respect to the long axis of the printed BCP line (FIG. 10c). On the other hand, the orientation of domains with respect to the substrate switches from parallel to perpendicular in the region of the brush. Simulations indicate that the alignment of parallel cylinders close to the region of the non-preferential brush is induced by the grain of perpendicular cylinders. This result provides an example of the unprecedented control of domain arrangement in and out of the plane, uniquely enabled by combined patterning of both the brushes and BCPs by e-jet printing. The thickness uniformity of the printed BCP films can help to ensure uniformity in patterns transferred via use of these films as resists. Printing BCPs in the form of filled pads with a high level of uniformity (roughness<2 nm) as described above and using lithographically defined trenches filled with BCPs via e-jet printing can provide high uniformity in thickness. BCPs with high etch selectivity or with subsequently hardened blocks can further enhance this uniformity.

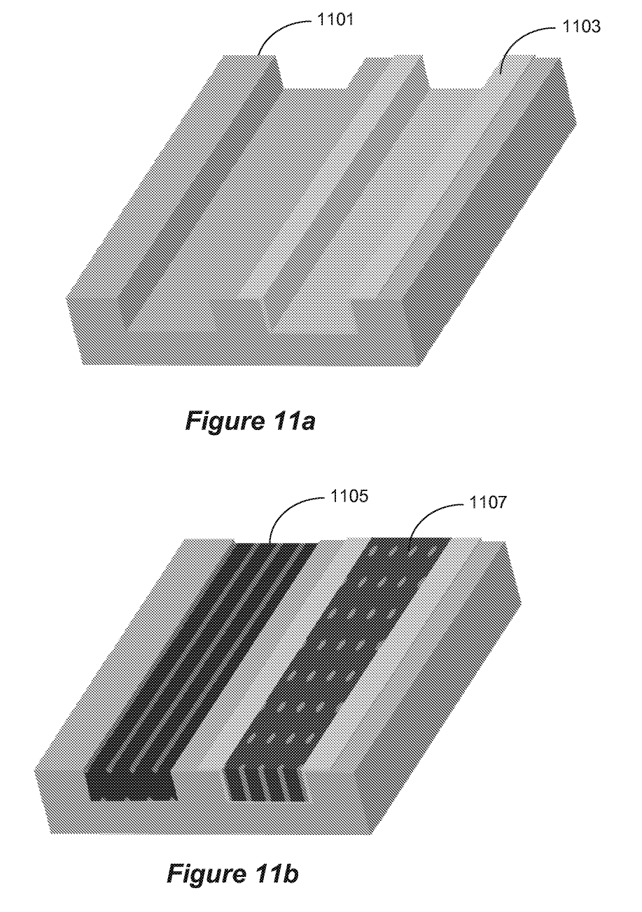

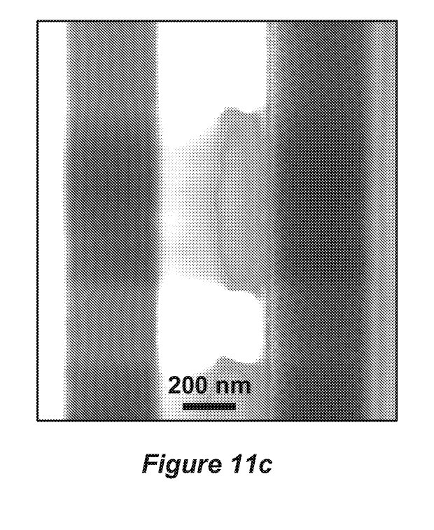

Combining printed brushes with substrates that support pre-defined, lithographic structures affords additional levels of control. In the example presented in FIG. 11a, features 1101 of HSQ defined by electron beam lithography on a silicon substrate yield topographical features with chemically homogeneous surfaces. Functionalization of bottoms and sidewalls of selected trenches with P(S-ran-MMA) by e-jet printing yields spatial control over the chemistry of these features. In FIG. 11a, the right trench is functionalized with P(S-ran-MMA) 1103 with the left trench left bare. This chemical contrast yields distinct wetting behaviors and assembly of a cylinder forming PS-b-PMMA on adjacent trenches as illustrated schematically in FIG. 11b. On the bare trench (left), cylinders lie parallel to the substrate surface, with a high level of in-plane alignment along the axis of the template. The neutral wetting behavior of the trench (right) functionalized with the brush leads to guided assembly of cylinders oriented perpendicular to the substrate. FIG. 11c shows an SEM image of an assembled spin-cast BCP film on a substrate as shown in FIG. 11a that combines topographical patterns with printed brushes. The SEM image shows parallel and perpendicular orientation of the domains within the trenches without and with brushes, respectively.

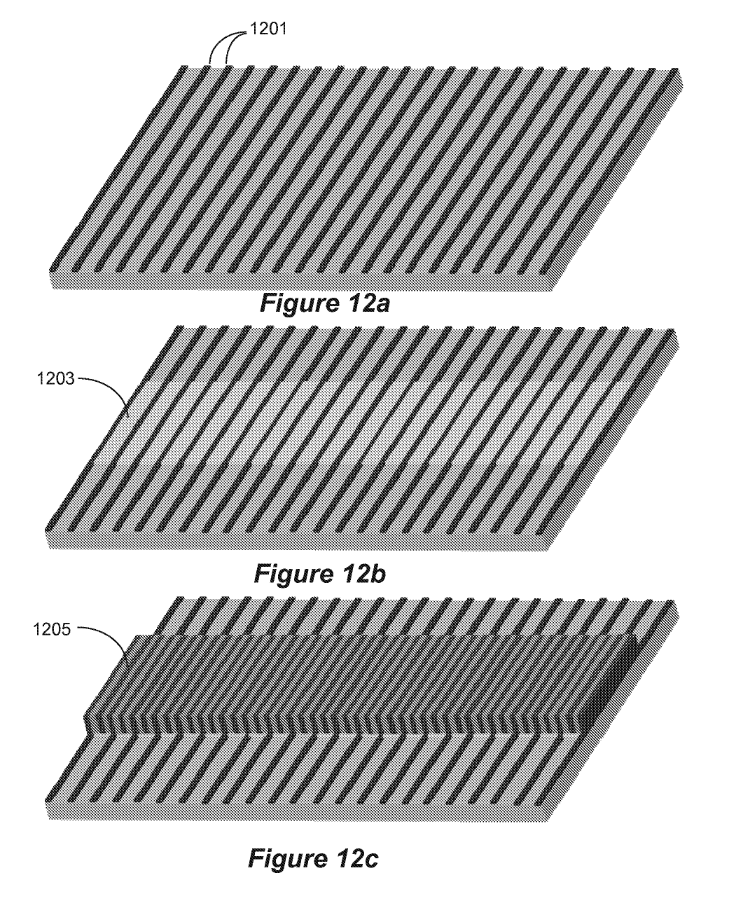

The thickness of the BCP film is important to achieving a high level of in-plane alignment of the perpendicularly oriented domains within trenches that have the same wetting behaviors on the bottom and sidewalls. These printing approaches can easily be adapted for DSA of BCP films that exploit chemical, rather than topographical, patterns: here, random copolymer brushes can be printed on top of the lithographically prepared templates to spatially define the one component of the binary chemical patterns. An example is shown in FIGS. 12a-12c, with FIG. 12a showing a lithographically prepared template of preferential guide stripes 1201; FIG. 12b showing a printed brush in a region 1203 perpendicular to the guide stripes 1201, and FIG. 12c showing an assembled BCP film 1205. Perpendicular orientation of the BCP film 1205 is induced only in the area having the random copolymer as background, in this case, the center region shown in FIG. 12b. The BCP film 1205 has lamellae at a density 3× the number of guide strips 1201, the lamellae having a length equal to the width of the region 1203. Any BCP outside this region (deposited, for example, by spin-casting) would have a parallel orientation induced by the preferential guide strips 1201. Alternatively, a BCP may be printed on the printed region of the wetting layer. The technique illustrated in FIGS. 12a-12c allows the formation of isolated line segments.

Example methods of e-jet printing of BCPs are described below:

Preparation of neutral wetting substrates: Silicon wafers (<100>, WRS Materials) were cleaned in a piranha solution (H₂SO₄:H₂O₂=7:3) at 130°60 C. for 30 min and then rinsed with water for 3 times 5 min each and then dried with N₂. A 0.2 wt % solution (toluene) of cross-linkable random copolymer (57% styrene, 39% methyl methacrylate and 4% glycidyl methacrylate) was spin-cast onto the clean silicon wafers and cross-linked at 250°60 C. for 5 min in a glove box filled with N₂.

Preparation of chemically patterned substrates: Chemical patterns of stripes (periodicity=84 nm) of a cross-linked PS mat separated by regions functionalized with a random copolymer brush (hydroxyl-terminated, 41% styrene 59% methyl methacrylate). Patterns were prepared with 193 nm immersion lithography using ASML XT: 1900Gi scanner as described previously.

Preparation of topographically patterned substrates: A 70 nm thick layer of hydrogen silsesquioxane (HSQ, Dow Corning) was spin-cast on a cross-linked random copolymer mat and patterned with electron beam lithography (JEOL JBX-6000F5). The exposed regions of the HSQ remain after development to serve as separating boundaries between trenches that display neutral functionality.

Nozzle and ink preparation: Pre-pulled glass pipettes (World Precision Instruments) with tip inner diameters of 500 nm, 1, 2, 5 and 10 μm were sputter coated (Denton, Desk II TSC) with Au/Pd. Metal coated nozzles were treated with a hydrophobic solution (0.1% perfluorodecanethiol in DMF) prior to printing for 10 min and then dipped in DMF for 10 s and then dried with air. A dilute (e.g., 0.1%) solution of PS-b-PMMA (25-26, 37-37 and 46-21 kg/mol, Polymer Source Inc.) in 1,2,4-trichlorobenzene (>99%, Sigma Aldrich) passed through a syringe filter (PTFE membrane, Acrodisk) with a pore size of 0.2 μm served as the ink.

E-jet printing and thermal annealing of the substrates: A voltage (300-450V) was applied between a metal-coated glass capillary and a grounded substrate with a standoff height of ˜30 μm. Spatial control of the printing process was provided by a 5-axis stage interfaced to a computer that allowed coordinated control of voltage applied to the nozzle. Unless otherwise stated, printed BCP films were annealed at 220°60 C. for 5 min in a glove box filled with N₂.

Characterization of printed BCP films: The surface morphologies of the printed BCP films were imaged with a field emission SEM (Hitachi S-4800) at 1 kV. The topography of the films was analyzed with an AFM (Asylum Research MFP-3D) in tapping mode using a silicon tip with aluminum reflex coating (Budget Sensors).

Example methods of e-jet printing of random copolymer brushes are described below:

Substrate, nozzle and ink preparation: Silicon wafers (<100>, WRS Materials) were cleaned using an oxygen plasma treatment (200 W, 200 mT, 20 sccm) for 5 min. Pre-pulled glass pipettes (World Precision Instruments) with inner nozzle diameters of 1 μm were coated (Denton, Desk II TSC) with Au/Pd by sputter deposition. The resulting metal coated nozzles were treated with a hydrophobic solution (0.1% perfluorodecanethiol in DMF) for 10 min and then dipped in DMF for 10 s and dried with air. A solution (0.1%-1%) of hydroxyl-terminated random copolymers in 1,2,4-trichlorobenzene (≧99%, Sigma Aldrich) served as the ink. Random copolymers were synthesized following the procedures reported in the previous study with styrene and methyl methacrylate compositions of 57%:43% (57S, ˜3 kg/mol), 62%:38% (62S, ˜12 kg/mol) and 76%:24% (76S, ˜10 kg/mol).

E-jet printing of brushes: A voltage (350-450V) was applied between a metal-coated glass capillary and a grounded substrate with a standoff height of ˜30 μm. For the results presented in FIG. 9, the voltage was chosen about 25 V higher than the minimum voltage (250-300 V depending on the printing conditions) required to initiate printing. Spatial control of the printing process was provided by a 5-axis stage interfaced to a computer for coordinated control of voltage applied to the nozzle.

Processing of printed brushes: The patterned substrate was annealed at 220°60 C. for 5 min in a glove box filled with nitrogen. After annealing, ungrafted polymers were removed by 3 cycles of sonication in warm toluene for 3 min per cycle and then dried with nitrogen. A film of BCP (37-37 and 46-21 kg/mol, Polymer Source Inc.) was then either spin-coated (Toluene) or printed (1,2,4-trichlorobenzene).

Characterization of polymer brushes and BCP film morphologies: The surface morphologies were imaged with a field emission scanning electron microscope (SEM, Hitachi S-4800) at 1 kV. The topographies of the printed polymer brushes and the BCP films were analyzed with an AFM (Asylum Research MFP-3D) in tapping mode using a silicon tip with aluminum reflex coating (Budget Sensors).

While the examples in the above description use PS-b-PMMA BCPs and P(S-r-MMA) random copolymers, the methods and compositions may use inks containing any appropriate BCP or random copolymer (e.g., P(A-b-B) or P(A-r-B) where A and B represent different monomers). Examples of blocks that may be useful in BCP lithography include poly(styrene) (PS), poly(4-fluorostyrene) (P4FS), poly(butadiene) (PB), poly(isoprene) (PI), poly(methyl methacrylate) (PMMA), poly(lactic acid) (PLA), poly(ethylene oxide) (PEO), poly(dimethylsiloxane) (PDMS), poly(2-vinylpyridine) (P2VP), polyferrocenyldimethylsilane (PFDMS), poly(trimethylsilylstyrene) (PTMSS), and poly(cyclohexylethylene) (PCHE). Random copolymer brushes used to direct the assembly of a BCP may contain one or both copolymers of the BCP.

Once formed, one of the domains of the BCP thin film can be removed, e.g., by an oxygen plasma, thereby creating raised of features of the other domain. The resulting topographic pattern can be transferred to the underlying substrate by using the topographic pattern as an etch mask to a second substrate using a molding or nanoimprinting process. Pattern transfer may have applications in the fabrication of integrated circuits, information storage, and nanoimprint templates, for example.

Although the foregoing has been described in some detail for purposes of clarity of understanding, it will be apparent that certain changes and modifications may be practiced within the scope of the disclosure. It should be noted that there are many alternative ways of implementing both the process and compositions of the present invention. Accordingly, the present implementations are to be considered as illustrative and not restrictive, and the disclosure is not to be limited to the details given herein.

1. A composition comprising:
a substrate;
self-assembled domains of a first block copolymer (BCP) on a first region of the substrate; and
self-assembled domains of a second BCP on a second region of the substrate, wherein the first and second BCPs differ in one or more of composition, molecular weight, and morphology.

2. The composition of claim 1, wherein the substrate is topographically or chemically patterned.

3. The composition of claim 1, wherein the self-assembled domains of the first BCP are oriented perpendicular to the substrate.

4. The composition of claim 3, wherein the self-assembled domains of the second BCP are oriented perpendicular to the substrate.

5. The composition of claim 1, wherein the first BCP is a P(A-b-B) BCP with the substrate preferential to the A block of the P(A-b-B) BCP over the B block.

6. The composition of claim 5, wherein the second BCP is a P(A-b-B) BCP.

7. The composition of claim 5, wherein the second BCP is a P(C-b-D) BCP with the substrate preferential to the C block of the P(C-b-D) BCP over the D block.

8. The composition of claim 1, wherein the first and second regions are separated by no more than 1 micrometer.

9. The composition of claim 1, wherein the self-assembled domains of the first BCP differ in size from the second BCP by a factor of 1.2 or more.

10. The composition of claim 1, wherein the self-assembled domains of the first BCP differ in size from the second BCP by a factor of 2 or more.

11. The composition of claim 1, wherein the self-assembled domains of the first BCP differ in size from the second BCP by a factor of 10 or more.

12. The composition of claim 1, wherein the self-assembled domains of the first BCP differ in size from the second BCP by a factor of 100 or more.

13. The composition of claim 1, wherein the self-assembled domains of the first BCP form lamellae and the self-assembled domains of the second BCP form cylinders.

14. The composition of claim 1, wherein the first and second BCPs are formed within a trench on the substrate.

15. A composition comprising:
a substrate; and
a thin film including self-assembled domains of a mixture of two or more block copolymers (BCPs) on the substrate, wherein one or more of the periodicity and morphology of the self-assembled domains vary continuously across the substrate.

16. The composition of claim 15, wherein the thin film forms a discrete region overlying the substrate.

17. The composition of claim 15, wherein the substrate is topographically or chemically patterned.

18. The composition of claim 15, wherein the self-assembled domains are oriented perpendicular to the substrate.

19. The composition of claim 15, wherein the BCP is a P(A-b-B) BCP with the substrate preferential to the A block of the P(A-b-B) BCP over the B block.

20. A method, comprising:
providing a substrate;
electrohydrodynamically printing an ink including a first block copolymer (BCP) on the substrate; and
inducing self-assembly of the first BCP to form a thin film comprising nanoscale domains of the BCP.

21-29. (canceled)
